(19) United States
(12) Patent Application Publication
(10) Pub. No.: US 2008/0265098 A1
(43) Pub. Date: Oct. 30, 2008

(54) Configuration and method of use of optimized cooperative space vehicles

(76) Inventors: Michael V. Connelly, Palos Verde Estates, CA (US); Christopher M. Cosner, Manhattan Beach, CA (US)

Correspondence Address: OSTRAGER CHONG FLAHERTY & BROITMAN, P.C., 570 LEXINGTON AVENUE, FLOOR 17, NEW YORK, NY, 10022-6894, US

(21) Appl. No.: 11/796,441

(22) Filed: Apr. 27, 2007

(51) Int. Cl. B64G 1/00

(52) U.S. Cl. 244/158.1; 244/158.4; 244/164; 244/171.1; 244/173.3

(57) ABSTRACT

A spacecraft system that includes a primary space vehicle and a secondary space vehicle, both of which are designed to optimize payload capacity and launch weight of the primary space vehicle. The primary and secondary space vehicles combine to form an on-orbit space vehicle capable of performing functions and maneuvers that exceed the physical capabilities of the primary space vehicle at the time of its launch. The spacecraft system is designed to minimize propellant containment-related disturbances while maintaining a standard level of functionality. The primary space vehicle is designed to be incapable of independently performing a propellant-intensive orbit change maneuver. Instead the primary space vehicle is designed to couple to a secondary space vehicle having propellant and thrust capability sufficient to perform an orbit change maneuver when the primary and secondary space vehicles are coupled. The secondary space vehicle may also be designed to deliver additional payload to the primary space vehicle.

### TECHNICAL FIELD

This disclosure relates generally to spacecraft and on-orbit interactions thereof. More particularly, this disclosure is related to systems and methods for optimizing the design of a cooperative primary space vehicle.

### BACKGROUND

As used herein, the term “primary space vehicle” shall mean any vehicle designed to perform a mission in space beyond the Earth's atmosphere or in orbit around the Earth, e.g., satellites that provide a user with a product or service such as communications, direct broadcast or remote sensing. A “cooperative” primary space vehicle is a primary space vehicle designed to facilitate docking or coupling with other space vehicles during its on-orbit life.

Primary space vehicles such as satellites tend to be costly to design, build and place in use. Satellites that cost hundreds of millions of dollars (or more) to design and build can also cost hundreds of millions of dollars to launch into space. Costs are directly related to the size, volume, weight and stowed mass properties of the satellite, as well as the load-carrying capability of the launch vehicle interface.

Primary space vehicles are typically sent on space missions for long periods of time and are equipped with completed payload suites, sufficient power capability for continued operation during their missions, and sufficient reserve propellant and thrust capabilities for adjustments to their orbits and other orbital maneuvers throughout their mission lives. Therefore, primary space vehicles are currently required to allocate a large on-board volume to store reserve propellant (e.g., in large tanks) and house the thrust and control systems necessary for performing such maneuvers and orbital adjustments. As a result, a significant portion of the available launch vehicle's lift capability, volume and load-carrying capacity must be allocated to launch the weight of the reserve propellant as well as the thrust and control systems. Likewise, primary space vehicles are currently required to have fully completed and integrated payload suites, allocating large on-board volumes to carry such equipment to deliver the products necessary to the mission.

Typically, a conventional primary space vehicle in orbit can undertake maneuvers that fall into two categories: (1) orbit maintenance maneuvers; and (2) orbit change maneuvers.

As used herein, the term “orbit maintenance maneuvers” means corrections to the degradation of an existing orbit due to secondary perturbations. These small maneuvers correct for the small forces and torques that cause an orbit to deviate from the intended ideal Keplerian orbit over time. Some of the sources of orbital perturbations include: Earth oblateness, solar winds, the influence of gravitational sources beyond the primary two bodies, etc. The goal of an orbit maintenance maneuver is to return the orbit to the original ideal six Keplerian elements after it has drifted away slightly over time.

As used herein, the term “orbit change maneuvers” means large maneuvers that are used to significantly change the shape, speed or direction of an orbit. An orbit change maneuver is intended to result in some substantive change to at least one of the ideal six Keplerian elements. Orbit change maneuvers are generally at least more than an order of magnitude larger than orbit maintenance maneuvers both in terms of the change in velocity (delta-V) required and in terms of weight of propellant used.

A conventional primary space vehicle comprises a bus system and a payload system. The bus is a group of subsystems whose primary function is to provide health and welfare support to the payload system. A bus is typically made up of an attitude determination, control and navigation system (ADCNS), an electrical power subsystem (EPS), harness (i.e., electrical wiring), propulsion, telemetry and command and digital electronics, and structure (i.e., passive mechanical elements). Payload is a grouping of subsystems whose primary function is the synthesis of end product functionality (such as communications equipment, direct broadcast equipment or remote sensors).

The bus system of a conventional primary space vehicle is typically configured with a large-force thrust module and a plurality of propellant tanks for the storage and containment of propellant for use at some time during the space vehicle's mission life. The payload capacity is quite limited in volume by the capacity of the propellant tanks. Any required movement is independently accomplished by the primary space vehicle using the on-board propellant and thrust module. A significant proportion of such primary space vehicles are non-cooperative, i.e., they are not designed for refueling, repair or otherwise extending their mission life. Therefore, conventional primary space vehicles are generally limited in mission duration and in their ability to alter their orbits during their mission life.

Further, the reserve propellant stored on such primary space vehicles may not be needed or utilized for many years, causing additional potential concerns. Space vehicles may suffer detrimental disturbances such as so-called “fuel slosh”, which term refers to the disturbance created by the unconstrained motion of propellant in zero-gravity on a space vehicle with partially filled propellant tanks. Space vehicles may also suffer from the chemical decomposition of their propellant via the interaction of the vehicle's tanks, residual traces from tank manufacturing and the volatile propellants, potentially resulting in a buildup of pressure in the tanks over the space vehicle's lifetime.

It would therefore be advantageous to reduce propellant and thrust requirements on a primary space vehicle, and to provide necessary propellant and thrust capabilities to the primary space vehicle in orbit only when they are required.

### SUMMARY

A space vehicle system is disclosed herein that optimizes the design of a primary space vehicle to take advantage of large reductions in volume, mass, launch weight and load-carrying capacity to the effect that an equally capable primary space vehicle can be launched using a smaller, less expensive launch vehicle and/or a more capable primary space vehicle (i.e., a space vehicle having a larger, more capable payload) can be launched without increasing the size and expense of the launch vehicle. The inventive concepts disclosed herein include the following aspects.

One aspect is a primary space vehicle that has the capabilities to carry payload, couple with a secondary space vehicle, and perform orbit maintenance maneuvers when not coupled to a secondary space vehicle, but that is incapable of performing an orbital change maneuver when not coupled to a secondary space vehicle.

Another aspect is a system comprising a primary space vehicle and a secondary space vehicle, each having the capability to couple with the other, wherein the primary space vehicle is capable of performing orbit maintenance maneuvers when not coupled to the secondary space vehicle, but is incapable of performing an orbital change maneuver when not coupled to the secondary space vehicle; and wherein the secondary space vehicle is capable of performing an orbital change maneuver when coupled to the primary space vehicle.

A further aspect is a primary space vehicle comprising an attitude determination control and navigation subsystem that is programmed to change the attitude of the primary space vehicle and/or make minor adjustments to the orbit of the primary space vehicle, wherein the primary vehicle is incapable of independently reshaping its orbit beyond minor adjustments.

Yet another aspect is a method of changing an orbital parameter of an orbiting primary space vehicle, comprising the following steps: configuring propellant reserves and thrust capability on a primary space vehicle to be insufficient to perform an orbital change maneuver; configuring propellant reserves and thrust capability on a secondary space vehicle to be sufficient to perform an orbital change maneuver when coupled to the primary space vehicle; coupling the secondary space vehicle to the primary space vehicle; and activating the secondary space vehicle to cause the coupled primary and secondary space vehicles to change an orbital parameter of the primary space vehicle.

Other aspects of the invention are disclosed and claimed below.

### BRIEF DESCRIPTION OF THE DRAWINGS

FIG. 1 is a block diagram showing the coupling of a primary space vehicle to a secondary space vehicle wherein the former lacks and the latter has the capability to perform an orbit change maneuver.

### DETAILED DESCRIPTION

In accordance with one embodiment, a primary space vehicle is configured to make minimal or no adjustments to maintain its orbit, but is not equipped to carry out an orbit change maneuver. Instead, when reshaping of the orbit of the primary space vehicle (i.e., an orbital change maneuver) is necessary, the primary space vehicle is coupled (i.e., docked) to a secondary space vehicle that is equipped to carry out such orbit change maneuver.

More specifically, the primary space vehicle is configured with propellant tank capacity and thrust capability sufficient for orbit maintenance, but insufficient for performing orbital change maneuvers. For example, a medium class space vehicle would have a propellant tank with a capacity to store no more than 200 pounds mass of propellant. This would substantially reduce the weight of the primary space vehicle and/or significantly increase the space available for carrying payload. For space vehicles carrying equal payloads, this reduction in the overall weight of the space vehicle will reduce launch costs. Alternatively, for equal launch costs, the reduction in the volume of propellant aboard the space vehicle will allow for increased payload.

In conjunction with the foregoing primary space vehicle configuration, the secondary space vehicle is configured with sufficient propellant reserves and large-maneuver thrust capabilities, and with means for approaching, docking and coupling with the primary space vehicle. The secondary spacecraft remains coupled to the primary space vehicle to perform tasks beyond the original independent capability of the primary space vehicle or to reshape the predetermined orbit (i.e., to perform an orbital change maneuver). For example, the secondary spacecraft may be used to re-fuel the primary space vehicle's small propellant tank to extend the mission life of the primary space vehicle or may be used to transfer equipment, such as a battery pack replacement or additional payload to increase the functionality of the primary space vehicle. The secondary spacecraft may also be configured with an attitude determination control and navigation subsystem, such that when coupled to the primary space vehicle, the secondary space vehicle performs navigation tasks for the coupled space vehicles.

The primary and secondary space vehicles disclosed herein combine to form a unique space architecture that becomes an on-orbit space vehicle system that is capable of performing functions and maneuvers that exceed the physical capabilities of the primary space vehicle at the time of its launch. The secondary spacecraft is configured to rendezvous and dock with the primary space vehicle to perform propellant-intensive maneuvers beyond maintenance and minimal adjustments to the predetermined orbit of the primary space vehicle, and to deliver additional payloads that either exceed the total allowable dry mass of the assigned launch vehicle or that did not meet the development schedule in time for the assigned launch date.

The design methodology for optimizing the primary space vehicle includes the optimization of the primary payload. A subset of the complete payload could be launched with the primary space vehicle and supplemented by additional components integrated with the secondary space vehicle at a later date. These additional components could include antennae, transmitters, receivers, or remote sensing equipment.

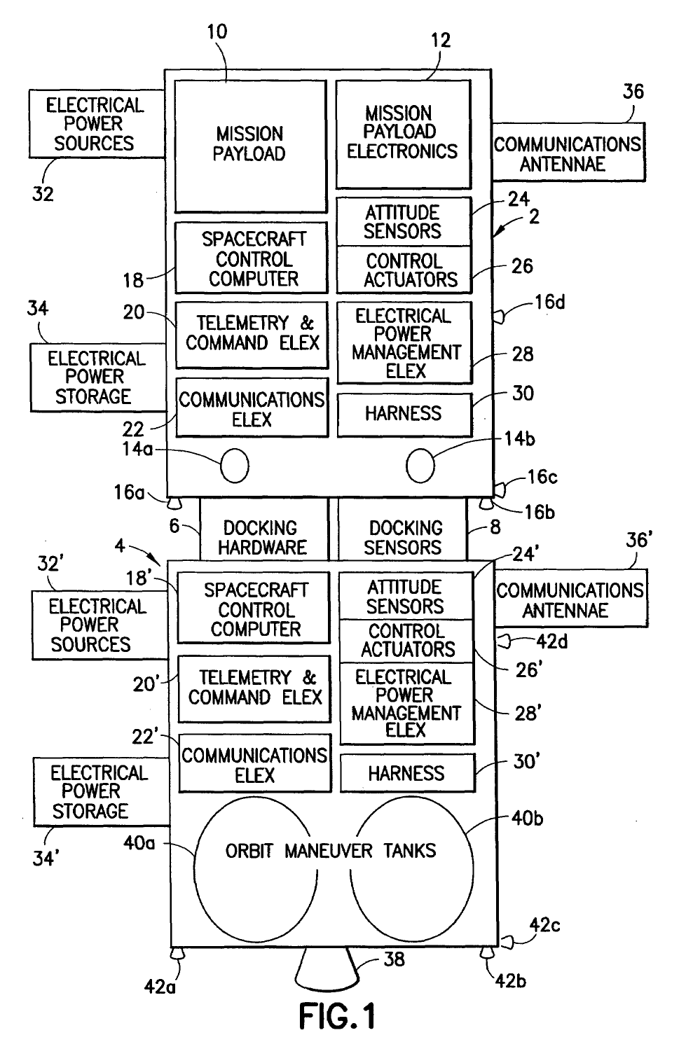

One embodiment incorporating an inventive concept disclosed herein is shown in FIG. 1, which is a functional block diagram. FIG. 1 depicts an orbiting spacecraft system consisting of a primary space vehicle 2 docked to a secondary space vehicle 4. The secondary space vehicle 4 comprises docking hardware 6 for coupling the primary and secondary space vehicles to each other and docking sensors 8 that detect whether the primary and secondary space vehicles are properly coupled. FIG. 1 shows the primary and secondary space vehicles in a fully coupled state.

The primary space vehicle 2 is designed to carry a mission payload 10 and mission payload electronics 12. To enable independent attitude adjustment or orbit maintenance by the primary space vehicle 2, the latter is provided with a plurality of reaction control thrusters, only four of which are depicted in FIG. 1 (see items 16a-16b). Reaction control thrusters are generally used for attitude control and are unable to produce the change in velocity needed to facilitate an independent orbit change maneuver by the primary space vehicle. However, the reaction control thrusters can be properly optimized for use in orbit maintenance. Moreover, the primary space vehicle 2 is provided with a plurality of small propellant tanks, only two of which are depicted in FIG. 1 (see items 14a and 14b). Preferably, the total propellant tank capacity aboard the primary space vehicle is smaller than what would be necessary for an independent orbit change maneuver by the primary space vehicle. More specifically, the total tank capacity is sized for reaction control propellant and not for orbit change maneuver propellant.

Other components of the primary space vehicle 2 include a spacecraft control computer 18, telemetry and command electronics 20, communications electronics 22, attitude sensors 24, control actuators 26, electrical power management electronics 28, harness 30, electrical power sources 32, electrical power storage 34 and communications antennae 36. These components are conventional and will not be described in detail herein.

Still referring to FIG. 1, the secondary space vehicle 4 is also provided with a plurality of reaction control thrusters, only four of which are depicted in FIG. 1 (see items 42a-42d). In addition, the secondary space vehicle 4 has a large-force thruster 38 capable of providing sufficient thrust for the coupled space vehicles to perform an orbit change maneuver. Alternatively, the required large maneuver thrust could be provided by a plurality of thrusters arranged to provide thrust of the same magnitude and in the same direction. The secondary space vehicle 4 is also provided with a plurality of large propellant tanks, only two of which are depicted in FIG. 1 (see items 40a and 40b). Preferably, the total propellant tank capacity aboard the secondary space vehicle is sufficient to enable an orbit change maneuver by the coupled space vehicles. More specifically, the total tank capacity is sized for reaction control propellant and for orbit change maneuver propellant.

Other components of the secondary space vehicle 4 include a spacecraft control computer 18′, telemetry and command electronics 20′, communications electronics 22′, attitude sensors 24′, control actuators 26′, electrical power management electronics 28′, harness 30′, electrical power sources 32′, electrical power storage 34′ and communications antennae 36′. As previously stated, these components are conventional.

In accordance with one method of use, the reaction control thrusters 42a-42d and the large-force thruster (or thrusters) 36 on the secondary space vehicle 4 are controlled to bring it into proximity with the orbiting primary space vehicle. More specifically, the secondary space vehicle is controlled so that its trajectory will intercept the primary space vehicle at a specific time and position on the orbit of the latter. During approach, the docking sensors 8 are used to provide feedback to the control system of the secondary space vehicle, which then operates the reaction control thrusters (e.g., items 42a-42d in FIG. 1) to bring the secondary space vehicle into docking relationship to the primary space vehicle. Then the docking hardware 6 is activated to couple the primary and secondary space vehicles to each other. Suitable on-orbit proximity procedures, including approach, docking and coupling, are described in commonly owned U.S. patent application Ser. No. 11/394,743, the disclosure of which is incorporated by reference herein in its entirety.

The optimized design of the primary space vehicle does not require any of the following: a large volume of propellant, large propellant tanks, large-force thrusters, or valves and filters necessary for delivering propellant from tanks to large-force thrusters. As previously discussed, the primary space vehicle 2 carries a relatively small volume of propellant, i.e., an amount insufficient for independent orbit change maneuvering. Therefore, for a primary space vehicle of desired total weight, the amount of payload can be increased as the weight of the propellant, propellant tanks, thrusters, valves, filters, etc. onboard is reduced.

Because the primary space vehicle lacks thrusters powerful enough to perform an orbit change maneuver independently, it is dependent for orbit change maneuvering on the thrust capabilities of the secondary space vehicle to which it is docked while in orbit. The secondary space vehicle is configured with propellant and thrust capabilities sufficient to enable the coupled space vehicles to perform an orbit change maneuver. After the orbit change maneuver, the coupled space vehicles will be traveling in the new orbit for the primary space vehicle. The secondary space vehicle can then be uncoupled from the primary space vehicle. The primary space vehicle will then continue on its new orbit.

As previously discussed, the secondary space vehicle has a large capacity for storing propellant and large-force thrusters for facilitating a desired change in orbit of the primary space vehicle. Because the secondary space vehicle, rather than the primary space vehicle, carries the weight associated with large-maneuver propellant and large-force thrusters, the primary space vehicle may carry additional payload weight.

Additionally, reducing the volume formerly occupied by large propellant tanks has the further benefit of reducing the height of the payload interface plane in the stowed conditions. The load-carrying capability at the launch vehicle interface is typically limited by the overturning moment produced when the primary space vehicle is acted upon by a lateral load. In the prior art, this overturning moment must be reduced by reducing the payload.

Thus an enhanced payload is facilitated not only because of the elimination of some mass of propellant, but also because of the newly available volume, because of the elimination of now unnecessary hardware in the propellant subsystem (i.e., tanks, valves, lines, large thrusters), and also because of the significantly reduced launch loads now applied to the payload due to the resulting lower stowed center of gravity.

For attitude determination and control, new mass properties of the re-optimized primary space vehicle result in changes to the required capabilities of the actuators. Modifications to the mission payload require modifications to the power and harness subsystems and likely additional on-board data requires modifications to the telemetry and control/digital subsystem design. All of these effects can be optimized when the two spacecraft, the primary and secondary vehicles, are considered as a system from the initial conceptualization of the design.

An additional technical benefit is the elimination of the requirement to accomplish long-term storage of propellant on board the primary space vehicle. Concerns of chemical decomposition via the interaction of multiple propellant tanks made of multiple metallic alloys, lines, valves and thrusters, as well as residual traces from manufacturing and the volatile propellants, are eliminated. A further technical benefit includes the elimination or minimization of the phenomenon referred to as “fuel slosh.” Fuel slosh is eliminated because large-maneuver propellant is not on board the primary space vehicle during the majority of its on-orbit life.

Furthermore, additional payload can be carried into orbit by the secondary space vehicle and then transferred to the primary space vehicle when the vehicles rendezvous. For example, the primary space vehicle's propellant tank may be re-fueled, additional functionality may be added to the primary space vehicle, or other parts may be serviced or replaced, such as battery packs. Exchange of payload may be accomplished by any methods known in the art.

While the invention has been described with reference to certain embodiments, it will be understood by those skilled in the art that various changes may be made and equivalents may be substituted for elements thereof without departing from the scope of the invention. In addition, many modifications may be made to adapt a particular situation to the teachings of the invention without departing from the essential scope thereof. Therefore it is intended that the invention not be limited to the particular embodiments disclosed herein, but that the invention will include all embodiments falling within the scope of the appended claims.

What is claimed is:

1. A primary space vehicle having the capabilities to carry payload, couple with a secondary space vehicle, and perform orbit maintenance maneuvers when not coupled to a secondary space vehicle, but being incapable of performing an orbital change maneuver when not coupled to a secondary space vehicle.

2. The primary space vehicle as recited in claim 1, comprising one or more propellant tanks having a total propellant storage capacity that is insufficient for an orbital change maneuver.

3. The primary space vehicle as recited in claim 2, wherein the primary space vehicle lacks equipment for transferring propellant from a secondary space vehicle to the propellant tank(s) of the primary space vehicle.

4. The primary space vehicle as recited in claim 1, comprising an attitude determination control and navigation subsystem that is not programmed to perform control functions for an orbital change maneuver.

5. The primary space vehicle as recited in claim 1, wherein the primary space vehicle lacks a thruster or thrusters capable of providing the amount of thrust needed for an orbital change maneuver.

6. The primary space vehicle as recited in claim 1, wherein the primary space vehicle can undergo a change in its orbital parameters when coupled to a secondary space vehicle having sufficient propellant and thrust capability to move the coupled primary and secondary space vehicles along an orbit having said changed orbital parameter.

7. A system comprising a primary space vehicle and a secondary space vehicle, each having the capability to couple with the other, wherein:
said primary space vehicle is capable of performing orbit maintenance maneuvers when not coupled to said secondary space vehicle, but is incapable of performing an orbital change maneuver when not coupled to said secondary space vehicle; and
said secondary space vehicle is capable of performing an orbital change maneuver when coupled to said primary space vehicle.

8. The system as recited in claim 7, wherein said primary space vehicle comprises one or more propellant tanks having a total propellant storage capacity that is insufficient for an orbital change maneuver.

9. The system as recited in claim 8, wherein said primary space vehicle lacks equipment for transferring propellant from said secondary space vehicle to said propellant tank(s) of said primary space vehicle.

10. The system as recited in claim 7, wherein said primary space vehicle comprises an attitude determination control and navigation subsystem that is not programmed to perform control functions for an orbital change maneuver.

11. The system as recited in claim 7, wherein said primary space vehicle lacks and said secondary space vehicle comprises a thruster or thrusters capable of providing the amount of thrust needed for an orbital change maneuver.

12. The system as recited in claim 7, wherein said primary space vehicle can undergo a change in its orbital parameters when coupled to said secondary space vehicle.

13. The system as recited in claim 12, wherein said secondary space vehicle has sufficient propellant storage capacity and thrust capability to move the coupled primary and secondary space vehicles along an orbit having said changed orbital parameter.

14. The system as recited in claim 7, wherein said secondary space vehicle comprises a payload exchange system configured to transfer payload from said secondary space vehicle to said primary space vehicle.

15. A primary space vehicle comprising an attitude determination control and navigation subsystem that is programmed to change the attitude of the primary space vehicle and/or make minor adjustments to the orbit of the primary space vehicle, wherein said primary vehicle is incapable of independently reshaping its orbit beyond minor adjustments.

16. The primary space vehicle as recited in claim 15, comprising one or more propellant tanks having a total propellant storage capacity that is insufficient for reshaping the orbit of the primary space vehicle beyond minor adjustments.

17. The primary space vehicle as recited in claim 16, wherein the primary space vehicle lacks equipment for transferring propellant from a secondary space vehicle to the propellant tank(s) of the primary space vehicle while in orbit.

18. The primary space vehicle as recited in claim 15, comprising an attitude determination control and navigation subsystem that is not programmed to perform control functions for reshaping the orbit of the primary space vehicle beyond minor adjustments.

19. The primary space vehicle as recited in claim 15, wherein the primary space vehicle lacks a thruster or thrusters capable of providing the amount of thrust needed for reshaping the orbit of the primary space vehicle beyond minor adjustments.

20. A method of changing an orbital parameter of an orbiting primary space vehicle, comprising the following steps:
configuring propellant reserves and thrust capability on a primary space vehicle to be insufficient to perform an orbital change maneuver;
configuring propellant reserves and thrust capability on a secondary space vehicle to be sufficient to perform an orbital change maneuver when coupled to said primary space vehicle;
coupling said secondary space vehicle to said primary space vehicle; and
activating said secondary space vehicle to cause said coupled primary and secondary space vehicles to change an orbital parameter of the primary space vehicle.
